(19) United States
(12) Patent Application Publication
(10) Pub. No.: US 2025/0005472 A1
(43) Pub. Date: Jan. 2, 2025

(54) Interactive Real-Time Parking Management

(71) Applicants: Anthony Balboni, Delran, NJ (US); Melissa Purnell, Delran, NJ (US); Robert Ferara, Delran, NJ (US)

(72) Inventors: Anthony Balboni, Delran, NJ (US); Melissa Purnell, Delran, NJ (US); Robert Ferara, Delran, NJ (US)

(21) Appl. No.: 18/215,165

(22) Filed: Jun. 27, 2023

(51) Int. Cl. G06Q 10/0631; G08G 1/14

(52) U.S. Cl. CPC G06Q 10/06312; G08G 1/141; G08G 1/148; G06Q 2240/00; G07F 17/24

(57) ABSTRACT

Ways to share parking information and transfer available parking spaces via a parking manager are described. The parking manager may be used by space holders to access a parking marketplace. Similarly, space seekers may be able to access the parking marketplace via the parking manager. The parking manager may receive updates from various entities and determine whether parking spaces in a given area are available or will become available. Space seekers may be able to bid for open or soon-to-be open spaces via the parking marketplace. Space holders may be able to offer held spaces via the parking marketplace.

### BACKGROUND

Many people may struggle to find parking at desirable locations, such as downtown, near the beach, etc.

Thus, there exists a need for ways to locate available parking at such locations.

### BRIEF DESCRIPTION OF THE SEVERAL VIEWS OF THE DRAWING

The novel features of the disclosure are set forth in the appended claims. However, for purpose of explanation, several embodiments are illustrated in the following drawings.

FIG. 1 illustrates an example overview of one or more embodiments described herein, in which a parking manager facilitates a parking space transfer;

FIG. 2 illustrates an example overview of one or more embodiments described herein, in which a parking manager confirms a parking space transfer;

FIG. 3 illustrates an example overview of one or more embodiments described herein, in which a parking manager collects and distributes parking information;

FIG. 4 illustrates a graphical user interface (GUI) associated with a space seeker of one or more embodiments described herein;

FIG. 5 illustrates a schematic block diagram of an environment of one or more embodiments described herein;

FIG. 6 illustrates a data structure diagram of an exemplary set of data structures of one or more embodiments described herein;

FIG. 7 illustrates a flow chart of an exemplary process that generates profiles for use by the parking manager;

FIG. 8 illustrates a flow chart of an exemplary process that generates parking updates;

FIG. 9 illustrates a flow chart of an exemplary process that collects parking information;

FIG. 10 illustrates a flow chart of an exemplary process that provides parking information;

FIG. 11 illustrates a flow chart of an exemplary process that connects a space seeker with a space holder;

FIG. 12 illustrates a flow chart of an exemplary process that connects a space holder with a space seeker;

FIG. 13 illustrates a flow chart of an exemplary process that reserves a parking space;

FIG. 14 illustrates a flow chart of an exemplary process that transfers a parking space;

FIG. 15 illustrates a flow chart of an exemplary process that authenticates space holders and space seekers; and

FIG. 16 illustrates a schematic block diagram of one or more exemplary devices used to implement various embodiments.

### DETAILED DESCRIPTION

The following detailed description describes currently contemplated modes of carrying out exemplary embodiments. The description is not to be taken in a limiting sense, but is made merely for the purpose of illustrating the general principles of some embodiments, as the scope of the disclosure is best defined by the appended claims.

Various features are described below that can each be used independently of one another or in combination with other features. Broadly, some embodiments generally provide ways to share parking information and transfer available parking spaces via a parking manager. The parking manager of some embodiments may be used by space holders to access a parking marketplace. Similarly, space seekers may be able to access the parking marketplace via the parking manager. The parking manager may receive updates from various entities and determine whether parking spaces in a given area are available or will become available. Space seekers may be able to bid for open or soon-to-be open spaces via the parking marketplace. Space holders may be able to offer held spaces via the parking marketplace.

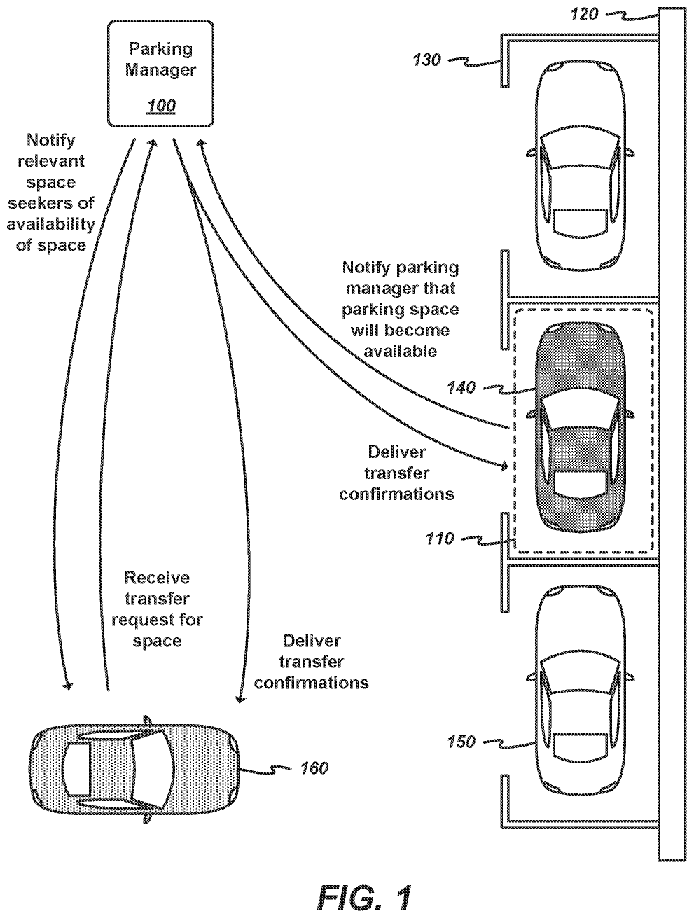

FIG. 1 illustrates an example overview of one or more embodiments described herein, in which a parking manager 100 facilitates a parking space transfer. As shown, in this example three parking spaces 110 may be defined by a curb 120 and a set of markings 130. A space of interest 110 may be occupied by space holder 140. Other spaces may be occupied by other space holders 150. A space seeker 160 may wish to obtain parking at one of the spaces 110.

Parking manager 100 may be an electronic device that is able to collect and distribute parking information. Parking manager 100 may be able to communicate across one or more networks (e.g., a cellular network, Wi-Fi, Bluetooth, the Internet, etc.). Parking manager 100 may be implemented using various sets of devices or components and/or various appropriate features. For instance, parking manager 100 may include, utilize, and/or otherwise be implemented via resources such as user devices (e.g., smartphones, tablets, personal computers, etc.), applications, web-based resources (e.g., a web-based portal or application, an application programming interface (API), etc.), etc. In some embodiments, parking manager 100 may direct or otherwise utilize resources such as vehicle sensors (e.g., cameras, global positioning system (GPS) sensors, accelerometers, etc.), user device sensors (e.g., cameras, microphones, GPS sensors, etc.), public resources (e.g., camera feeds), parking resources (e.g., parking meters, resources associated with a parking facility such as a lot or garage, etc.), and/or other appropriate resources that may be available to the parking manager 100.

Each parking space 110 may be defined or limited in various appropriate ways. For example, an area associated with a parking space 110 may be at least partly defined by physical barriers such as a curb 120, lines or markings 130, and/or other appropriate features (e.g., a paved section of a yard forming a driveway, a parking resource such as a parking meter, and/or other appropriate features). In some cases, parking spaces 110 may be automatically identified, such as by analyzing captured image data to identify parking spaces 110 based on physical features such as barriers 120 and/or markings 130. In some cases, parking spaces 110 may be manually defined by an administrator or other appropriate entity (e.g., by entering GPS coordinates or other location data associated with a space 110 into an application or web portal of some embodiments).

In some cases, parking spaces 110 may be defined in real-time or near real-time based on available data. For example, a gravel parking lot or temporary parking area (e.g., a section of lawn) may not include any markings or other references. Spaces 110 may be defined relative to previously parked vehicles 150 (e.g., a size of a rectangular area may be known or calculated and parking spaces 110 may be defined based on the available area and arrangement of previously parked vehicles) and/or other identifiable structures or barriers. Spaces of interest 110 may typically be associated with high usage areas, such as downtown, beachfront, near shopping or other attractions, etc.

Although many examples throughout this disclosure may discuss parking spaces 110, one of ordinary skill in the art will recognize that features provided via the parking manager 100 may be applied to various other elements and/or various other settings. For example, similar features may be applied to a place in line (e.g., a line of customers waiting for entry to a retail store, a line of customers waiting to purchase event tickets, etc.). As another example, similar features may be applied to a space or area such as a location on the beach (e.g., a section of a sandy area, a beach chair, etc.), at a park (e.g., a section of a grassy area, a park bench, etc.), or other desirable area.

Curb or barrier 120 may include, or be, various physical elements or structures that restrict movement of vehicles or other entities, such as people. Example barriers 120 may include curbs, fences, walls, buildings or similar structures, bollards, stanchions, gates, etc. Barriers 120 may include temporary or movable barriers, such as fence sections, cones, signage, queue barriers, etc.

Space markings 130 may include, for example, painted markings on a roadway, parking lot, or other surface. Markings 130 may include, or utilize, electronic devices such as beacons that may be perceived by user devices or other appropriate elements. Markings may include signs or other instructions.

Space holder 140 may include a vehicle or other entity (e.g., a trailer, a storage container, etc.). Space holder 140 may be associated with user devices, vehicle components (e.g., a vehicle head unit, a vehicle network or communication link, etc.). Space holder 140 may be able to interact with parking manager 100 across one or more networks or other communication pathways. Space holder 140 may be associated with a user or other similar entity.

Other space holders 150 may include, or be, vehicles or similar elements that occupy a parking space 110. Space holders 150 may be similar to space holders 140. In this example, other space holders 150 may not interact with parking manager 100 and/or may not have relevant information to share. Of course, in some cases other space holders 150 may also be able to communicate with parking manager 100.

Space seeker 160 may include a vehicle or other entity that wishes to obtain a parking space 110. Space seeker 160 may be associated with user devices, vehicle components (e.g., a vehicle head unit, a vehicle network or communication link, etc.). Space seeker 160 may be able to interact with parking manager 100 across one or more networks or other communication pathways. Space seeker 160 may be associated with a user or other similar entity.

In this example, a space holder 140 may notify the parking manager 100 that the space 110 will become available. For instance, a user may utilize a resource such as a user device app, web portal, or similar, to indicate that the user (and associated space holder 140) will be departing the parking space 110 within thirty minutes. As another example, the parking manager 100 may monitor the status of the parking space 110 and determine that the space holder 140 will vacate the space within thirty minutes (e.g., based on parking meter information, based on time limits associated with the parking space 110, and/or based on other relevant factors).

In some cases, compensation may be associated with transfer of a space 110. For example, space holder 140 may indicate a desired compensation for transfer of the space. As another example, parking manager 100 may determine a compensation value for transfer of the space. As still another example, a space holder 140 may initiate an auction of a space 110 via parking manager 100 such that space seekers 160 may bid for the space 110. Such compensation may include, for instance, partial payment of any parking fees, a specified monetary value, and/or other appropriate compensation (e.g., parking credits or rewards).

Parking manager 100 may notify relevant space seekers 160 of the availability of the space 110 (e.g., whether the space 110 is available or is predicted to become available). Such notification may include, for instance, push notifications, updates to a database or other resources, etc. In some cases, space seekers 160 may search for available or soon-to-be available spaces 110 and receive a listing or similar roster of such spaces 110. The notification may include information such as a space identifier, space holder identifier, estimated time of availability, and/or other relevant information). The notification may include compensation information (e.g., a cost to transfer the space 110).

Parking manager 100 may receive a transfer request for the space 110 from the space seeker 160. The transfer request may include information such as the space identifier, space holder identifier, anticipated or desired time of transfer, and/or other relevant information. The transfer request may further include acknowledgement of specified compensation or an offer of compensation (e.g., a space seeker 160 may offer additional compensation to ensure access to the space, or may offer reduced compensation based on predicted availability of alternative accommodations).

The space holder 140 and space seeker 160 may communicate via the parking manager 100 to determine a compensation that is acceptable to both. Once the space holder 140 and space seeker 160 agree to a compensation amount, the parking manager 100 may finalize the transaction (e.g., by processing a payment or transfer from the space seeker 160 to the space holder 140) and deliver transfer confirmations to the space holder 140 and the space seeker 160. Such confirmations may include information such as, for instance, identifying information related to the space seeker 160 (e.g., vehicle make, model, color, estimated arrival time, etc.), information related to the parking space 110 (e.g., exact location), identifying information related to the space holder 140 (e.g., vehicle make, model, color, estimated departure time, etc.), and/or other relevant information.

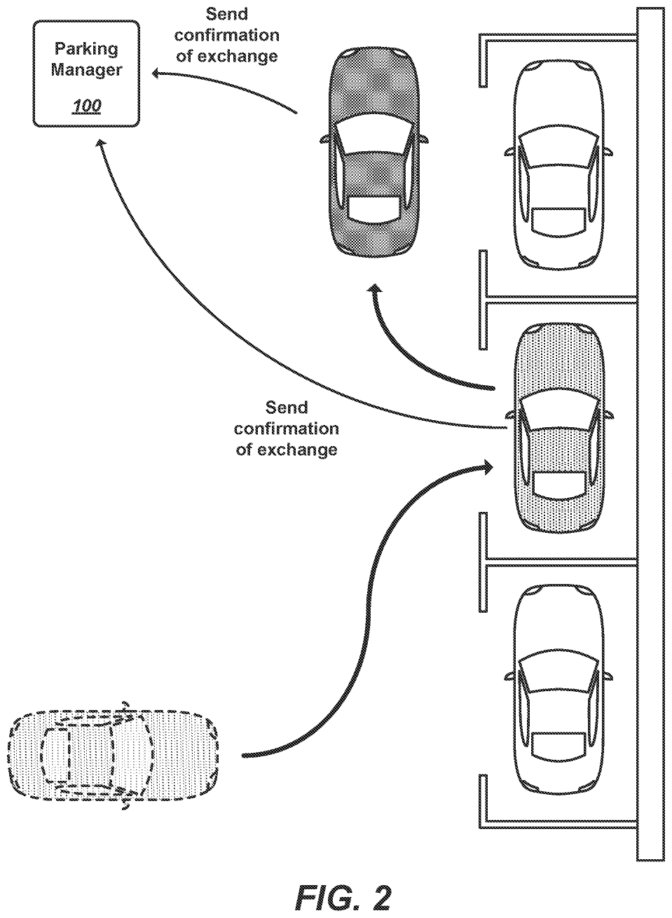

FIG. 2 illustrates an example overview of one or more embodiments described herein, in which a parking manager 100 confirms a parking space 110 transfer. Continuing the example above, space holder 140 may physically vacate the space after receiving the transfer confirmation and/or verifying that the space seeker 160 is able to take possession of the space 110 (e.g., based on location information, visual verification, etc.).

After the space 110 has been vacated, space seeker 160 may occupy the parking space 110, completing the transfer. The previous space holder 140 and the space seeker 160 (now a space holder) may send confirmation messages to the parking manager 100 confirming the exchange. The parking manager 100 may facilitate billing and payment, distribute funds or rewards, and/or otherwise finalize the exchange. The parking manager 100 may also update information related to current parking availability to reflect the new occupant of the space 110.

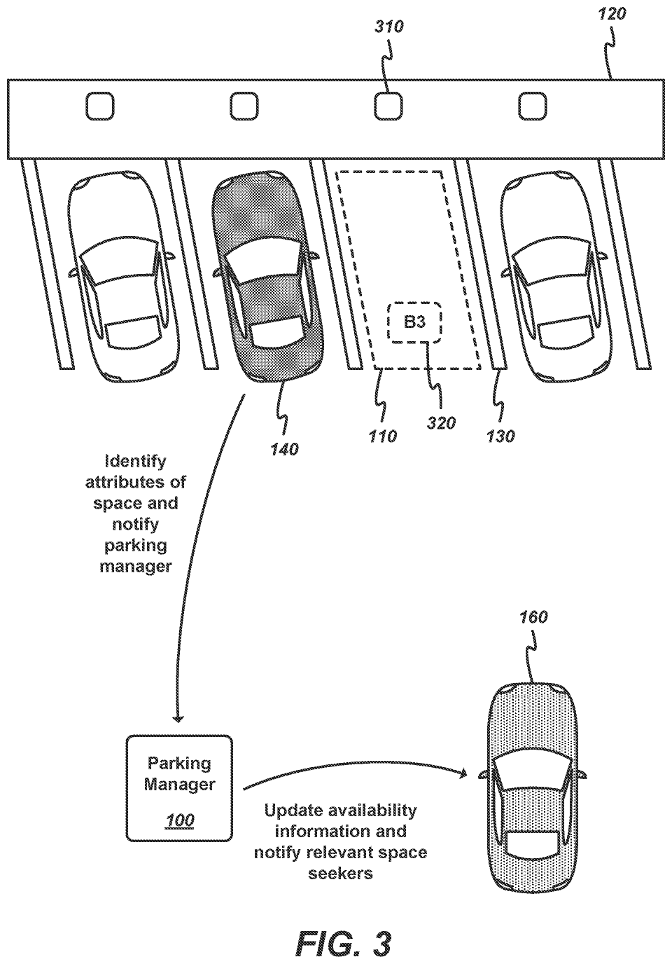

FIG. 3 illustrates an example overview of one or more embodiments described herein, in which a parking manager 100 collects and distributes parking information. In this example, a space holder 140 may have arrived at an open space 110, identified attributes of the space 110, and notified the parking manager 110 of the change in status associated with the space 110. Attributes identified by the space holder 140 may include, for instance, a space identifier, parking restrictions (e.g., time limits, fees, etc.), availability of nearby spaces 110, etc.

In this example, space holder 140 may be associated with a vehicle and/or user device that includes various sensors (e.g., cameras) and/or communication elements (e.g., Bluetooth) that may be able interact with components such as parking resource 310 and/or capture data (e.g., image data) that may be analyzed to determine relevant parking information.

Each parking resource 310 may be, include, and/or utilize an element such as a parking meter, parking payment kiosk, and/or other similar elements. Parking resource 310 may provide information such as parking restrictions (e.g., maximum time), fees (e.g., price per hour), and/or other relevant information (e.g., restrictions associated with vehicle type).

Each space label 320 may include identifying information that may be utilized by parking manager 100 to identify a parking space 110 (e.g., by matching a location and visual marking to a database of known spaces).

Based on the update received from space holder 140, parking manager 100 may update availability information and notify relevant space seekers 160 that the “B3” parking space 110 is available (and/or provide additional information such as cost, expected duration of availability, and/or other relevant information). Space seeker 160 may be able to proceed to the location of the associated open space 110.

Although many examples throughout this disclosure may discuss parking of vehicles such as automobiles, one of ordinary skill in the art will recognize that similar features may be applied to other types of vehicles such as motorcycles, boats, bicycles, scooters, etc. and/or other types of spaces (e.g., dock spaces, bicycle rack spaces, etc.).

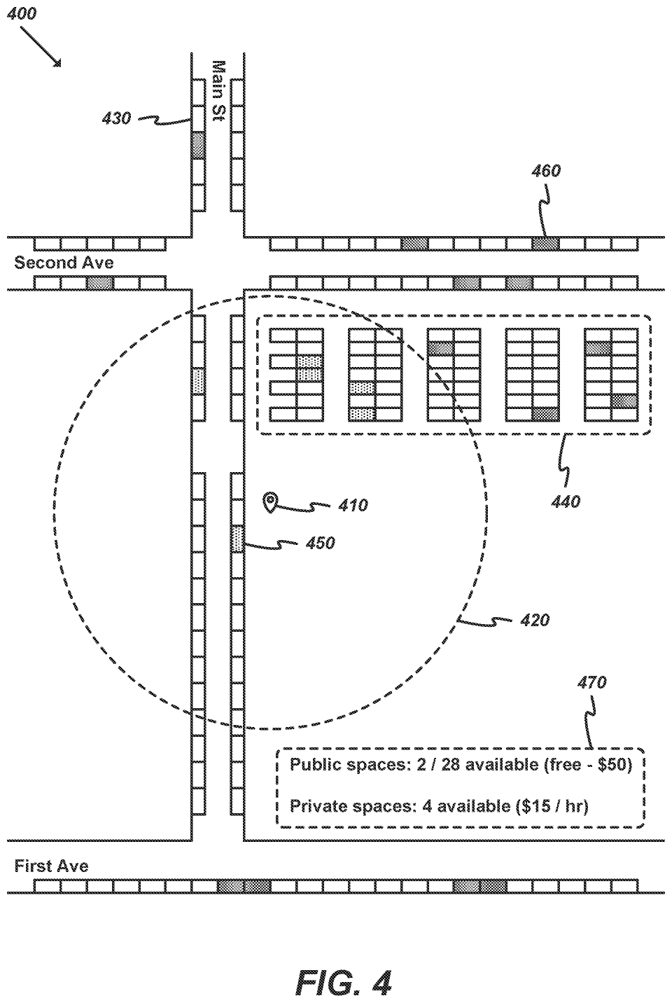

FIG. 4 illustrates a GUI 400 associated with a space seeker of one or more embodiments described herein. Such a GUI 400 may be utilized by, for example, space seekers 160 to identify available or soon-to-be available spaces 110. Other GUIs or similar features may allow users such as space holders 140 and space seekers 160 to negotiate compensation, agree to transfer, verify transfer, and/or otherwise interact with parking manager 100 and/or other users thereof.

Destination 410 may be a location (e.g., a street address) selected or indicated by a user such as a space seeker 160. Region of interest (ROI) 420 may include a region about the destination 410. In this example, the ROI 420 is circular, with a fixed radius about the destination 410, but different embodiments may include differently shaped ROIs 420 (e.g., rectangular, polygonal, irregular, etc.). In some cases, ROI 420 (or limits thereto) may be at least partly defined based on various criteria (e.g., on-street parking in front of the Ritz Hotel, parking along the East side of Main Street, etc.) in addition to, or in place of, attributes such as a destination 410 and radius about the destination.

Each parking space 110 may be represented as a rectangular area 430 and/or other appropriate visual representation. Private parking region 440 may be associated with an entity such as a parking lot or garage that is associated with multiple spaces 110. Spaces 110 outside such private parking regions 440 may include public spaces 110 (e.g., street parking that is administered by a regional entity or government), spaces 110 associated with private residences (e.g., driveway spaces), and/or any other accessible area where parking is allowed.

Available parking spaces 450 within the ROI 420 are indicated using a first fill pattern and available parking spaces 460 outside the ROI 420 are indicated using a second fill pattern. Different GUIs may indicate such status(es) in various appropriate ways (e.g., different icons, different colors, different shapes, etc.).

Each GUI feature 470 may provide relevant information such as a summary of available spaces 110, associated cost, time of availability, and/or other relevant information. GUI 400 may include various other features, such as buttons, input elements (e.g., an address entry field), etc. GUI features 470 may be selectable or otherwise be interactive, such that for example, a user may be able to retrieve details related to a specific space 110 (e.g., location, cost or compensation, predicted availability, etc.), modify the destination 410 (e.g., by entering a different address) and/or ROI 420 (e.g., by changing the radius value to increase or decrease the ROI area).

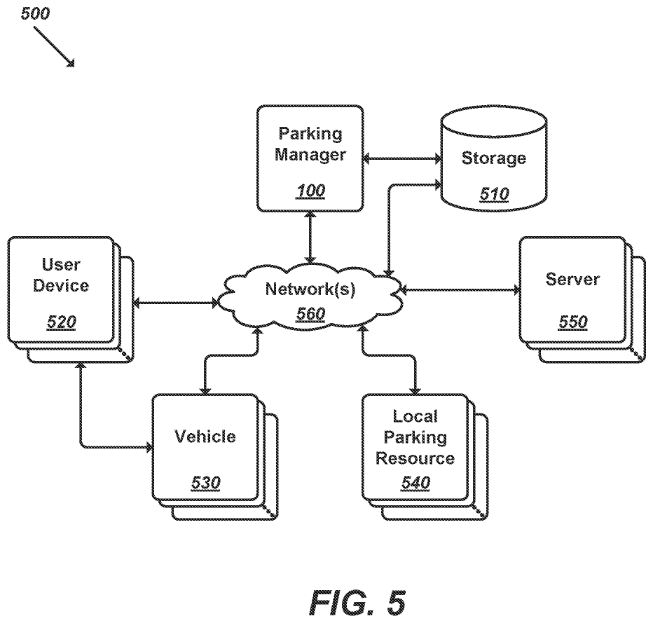

FIG. 5 illustrates a schematic block diagram of an environment 500 of one or more embodiments described herein. As shown, environment 500 may include parking manager 100, storage 510, user devices 520, vehicles 530, local parking resources 540, servers 550, network(s) 560, and/or other appropriate elements.

Parking manager 100 may be, include, and/or utilize electronic components such as servers, storages, processors, etc. Parking manager 100 may include a communication interface that may allow parking manager 100 to communicate across various networks 560 and/or other communication channels.

Storage 510 may be, include, and/or utilize various electronic devices, components, and/or systems that are able to store instructions and/or data. Storage 510 may be accessible through a resource such as an API.

Each user device 520 may be an electronic device such as a smartphone, tablet, personal computer, wearable device, etc. Each user device 520 may typically include or utilize a number of user interface (UI) features, such as buttons, keypads, touchscreen and/or displays, touchpads, mice, etc. Each user device 520 may be able to communicate across networks 560 and/or other communication channels.

Each vehicle 530 may be, include, or utilize components such as an automobile, truck, boat, motorcycle, bicycle, etc. Each vehicle 530 may be able to communicate across networks 560 and/or other communication channels. Vehicles 530 may include, utilize, and/or otherwise be associated with various resources such as sensors (e.g., cameras, motion detectors, distance or proximity sensors, location sensors, etc.), UI features (e.g., a vehicle head unit), and/or other appropriate resources.

Each local parking resource 540 may include, be, and/or utilize components such as parking meters, gates or other access controls, etc. Each local parking resource 540 may be able to communicate across networks 560 and/or other communication channels.

Each server 550 may be, include, and/or utilize electronic components capable of executing instructions and/or otherwise processing data. Servers 550 may be associated with resources such as parking administrators (e.g., a regional database of rules, rates, and/or regulations), payment processing features (e.g., money transfer utilities, credit card or other payment processing resources, etc.), event administrators (e.g., a schedule of events associated with a stadium), and/or other relevant resources.

Network(s) 560 may include various local and/or distributed communication pathways, such as wired or wireless channels (e.g., Bluetooth), cellular networks, ethernet, Wi-Fi, the Internet, etc.

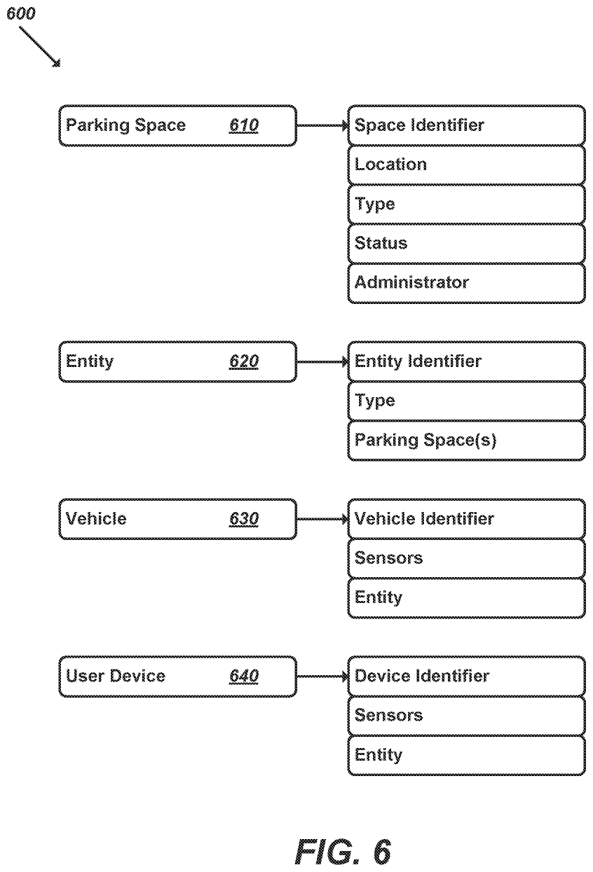

FIG. 6 illustrates a data structure diagram of an exemplary set of data structures 600 of one or more embodiments described herein. The set of data structures is provided for exemplary purposes and one of ordinary skill in the art will recognize that different embodiments may utilize various different sets of data structures including various different elements and/or sub-elements.

Each parking space structure 610 may be associated with a physical parking space and may include elements such as, for example, a unique space identifier (e.g., serial number), location information (e.g., a set of GPS coordinates, space size information, etc.), space type (e.g., unrestricted, time limited free parking, time limited for fee parking, private, special use (e.g., spaces for disabled users), etc.), space status (e.g., vacant, occupied, unknown, special, unavailable, etc.), and space administrator, if any (e.g., owner of a private space, enforcement authority associated with public spaces, etc.), and/or other appropriate elements. Information such as the space administrator may include a reference to another data structure (e.g., the unique identifier associated with an entity structure 620).

Each entity structure 620 may be associated with a user (e.g., a space holder, a space seeker, a space owner, etc.) or other entity (e.g., a parking authority) relevant to parking manager 100. In this example, each entity structure 620 may include elements such as, for example, a unique entity identifier (e.g., a serial number), an entity type (e.g., vehicle user, space administrator, government or enforcement entity, etc.), a listing of associated parking spaces (if any), and/or other appropriate elements (e.g., a listing of associated vehicles, user devices, etc.). Such associated elements (e.g., parking spaces, vehicles, user devices, etc.) may be indicated via references to other data structures (e.g., the unique identifier associated with such structures).

Each vehicle structure 630 may be associated with a vehicle 530 or other element that a user may wish to park or store. In this example, each vehicle structure may include elements such as, for example, a unique vehicle identifier (e.g., a serial number), a listing of sensors or sensor types associated with the vehicle (e.g., GPS sensors, cameras, specific sensor identifiers (e.g., a serial number or address associated with a specific sensor or set of sensors), etc.), an associated entity or listing of associated entities (e.g., a reference including the unique identifier associated with an entity structure 620), and/or other appropriate elements (e.g., a listing of associated user devices, type of vehicle, space requirements such as minimum size, etc.).

Each user device structure 640 may be associated with a user device 520 or similar component. Each user device structure 640 may include elements such as, for example, a unique device identifier (e.g., a serial number), a listing of sensors or sensor types associated with the device (e.g., GPS sensors, cameras, specific sensor identifiers, etc.), an associated entity or listing of associated entities (e.g., a reference including the unique identifier associated with an entity structure 620), and/or other appropriate elements (e.g., a listing of associated vehicles, type of device, etc.).

The various data structures 610-640 described above may be implemented using various elements or arrangements. For example, all parking space structures 610 may be included in a lookup table or similar structure such that each parking space structure 610 may be identified via the unique space identifier. As another example, a vehicle manufacturer may maintain a database that may be accessible via a resource such as server 550 and/or an associated API, where the vehicle identifier (e.g., a vehicle identification number (VIN) may be used to extract relevant information related to a vehicle of interest).

One of ordinary skill in the art will recognize that the set of data structures 600 is provided for exemplary purposes and different embodiments may utilize various different structures than those described herein. For example, in some embodiments the set of data structures 600 may include a server structure that is similar to user device structure 640 and includes information related to a server 550. As another example, in some embodiments, the set of data structures 600 may include a local parking resource structure that is similar to user device structure 640 and includes information related to a local parking resource 540.

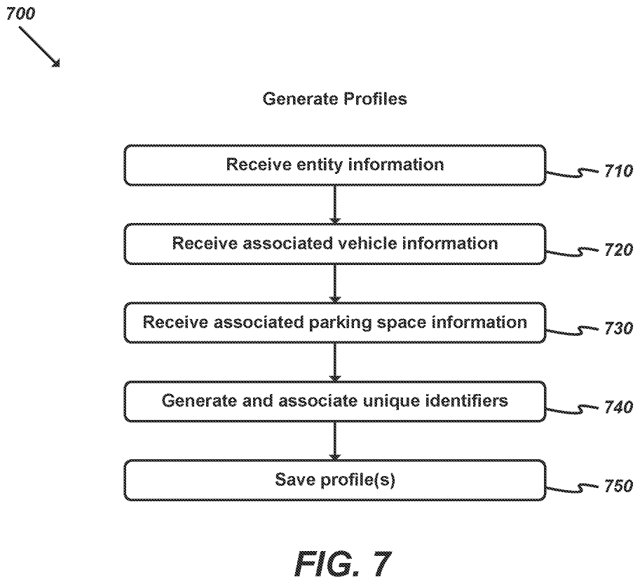

FIG. 7 illustrates an example process 700 for generating profiles for use by the parking manager 100. Such profiles may allow for creation of new entities and/or managing associations between entities (e.g., users, vehicles, parking spaces, etc.). The process may be performed whenever a new entity is identified (e.g., a parking space based on analysis of image data, a new user account is created via an application or web portal, etc.). In some embodiments, process 700 may be performed by parking manager 100.

As shown, process 700 may include receiving (at 710) entity information. Entity information may be received via various UI and/or GUI elements which may be provided via user devices 520, vehicles 530, local parking resources 540, server 550, and/or other appropriate components. Entity information may include, for example, the entity identifier (for a previously added entity) or the equivalent (e.g., a unique username), entity biographic or demographic information (e.g., user type, vehicle make and model, etc.).

Process 700 may include receiving (at 720) associated vehicle information, if any. As above, such information may be received via various UI and/or GUI elements provided via various resources associated with the parking manager 100. Vehicle information may include, for example, the vehicle identifier (for a previously added vehicle), vehicle biographic and/or demographic information (e.g., year, make, model, etc.), and/or other relevant information related to the vehicle (e.g., available sensors, communication capabilities, etc.). Vehicle information may be received via a resource such as server 550. For instance, a manufacturer may provide information via a web site, API, and/or other appropriate resource and information such as a VIN or model information may be used to collect information related to the vehicle (e.g., size or dimension information, available sensors, etc.).

The process may include receiving (at 730) associated parking space information, if any. As above, such information may be received via various UI and/or GUI elements provided via various resources associated with the parking manager 100. Parking space information may include, for example, the parking space identifier (for a previously added parking space), location or dimensions of the space, type of space, status of the space, and/or other relevant information related to a parking space.

In some embodiments, parking spaces may be automatically identified or generated. For example, image data captured via a user device 520 and/or vehicle 530 may be analyzed to identify physical barriers 120 and/or markings 130 that may define one or more spaces 110. Such space locations may be estimated or derived from data such as nearby space information, known landmarks or guideposts, position information associated with a vehicle 530 or user device 520, and/or other relevant data.

As shown, process 700 may include generating and associating (at 740) unique identifiers to the received entity, vehicle, and/or parking space information. For any new entities, vehicles, or parking spaces a unique identifier may be generated and associated with the entity, vehicle, or parking space, respectively. The unique identifier may be a serial number or similar identifier and may be generated in various appropriate ways (e.g., by identifying a next available identifier from a list of sequential identifiers, by transforming or utilizing unique information associated with the entity, vehicle, or parking space (e.g., username, VIN, GPS coordinates, etc.).

Process 700 may include saving (at 750) a set of profiles based on the received information. The generated profiles may be saved to a resource such as storage 510 and may be available to the parking manager 100 and/or other resources, such as user devices 520, vehicles 530, local parking resources 540, servers 550, etc. Such profiles may be stored using structures such as data structures 610-640 described above.

A similar process may be used to generate various other types of profiles (e.g., parking facility profiles, regional profiles, etc.) that may be utilized by the parking manager 100.

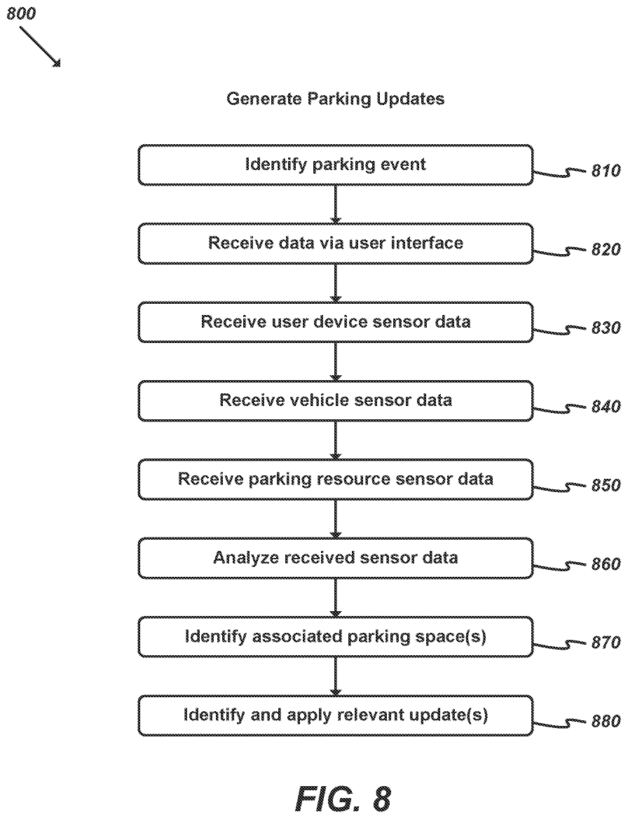

FIG. 8 illustrates an example process 800 for generating parking updates. The process may receive data from various sources and analyze the received data in order to update current parking information (e.g., space availability, predicted availability, offers of held spaces, requests for spaces, etc.). The process may be performed whenever a parking event occurs and/or information otherwise becomes available. In some embodiments, process 800 may be performed by parking manager 100.

As shown, process 800 may include identifying (at 810) a parking event and/or parking conditions. Parking events may be associated with resources such as event profiles that define various criteria associated with a parking event. If the criteria are partially or totally satisfied, a parking event may be identified. Received data may be compared with event profiles to identify parking events. In some embodiments, parking events may be identified using resources such as machine learning modules (e.g., such models may be used to analyze captured image data, vehicle sensor data, and/or user device sensor data to identify parking events). Example parking events may include, for instance, “space occupied”, “space vacated”, “space transferred”, “space requested”, “space reserved”, etc. Example parking conditions or “states” may include, for example, “occupied”, “vacant”, “unavailable”, “unknown”, etc.

Parking events and/or parking conditions may be identified in various ways via various appropriate resources. For instance, sensors associated with a vehicle 530 may be used by parking manager 100 to identify a parking event based on measured speed (e.g., when a vehicle stops for a time greater than some threshold duration at a location that is not associated with a roadway) and/or other vehicle data (e.g., when a vehicle transmission is placed in “park”). The inverse of such parking events may also be parking events (e.g., when a vehicle moves from a parking space, when a vehicle transmission is placed in “drive”, etc.). As another example, image data captured by one or more vehicle cameras may be used by parking manager 100 to identify parking events (e.g., whether a nearby space has been occupied or vacated) and/or conditions (e.g., whether a space next to a vehicle is vacant or occupied). As still another example, a UI or GUI may allow a user to enter event data (e.g., by identifying a parking space occupied by the user, by requesting a space within a ROI, etc.).

In some cases, parking manager 100 may identify parking conditions and/or event data for multiple associated spaces. For example, one or more images of an area of a private lot may be received at the parking manager 100 and analyzed to identify events and/or conditions. As another example, updates from a parking attendant may be received via a resource such as a GUI and the states of multiple spaces associated with a private lot may be updated based on the received updates.

Process 800 may include receiving (at 820) data via a UI. Such data may include, for instance, identification of a parking space, vehicle identification, intended duration of stay, and/or other relevant information. In some embodiments, such data may include compensation information (e.g., a user may indicate a minimum fee to transfer a space to another user, a user may indicate a maximum fee to transfer a space from another user, etc.).

The process may include receiving (at 830) user device sensor data. Such data may include, for example captured image data, GPS or other positioning data, and/or other relevant data from a user device 520.

As shown, process 800 may include receiving (at 840) vehicle sensor data. Such data may include, for example, captured image data, GPS or other location data, and/or other relevant data received from a vehicle 530.

Process 800 may include receiving (at 850) parking resource sensor data. Such data may include, for instance, time to expiration of a metered parking space, information related to associated parking spaces, and/or other relevant information.

The data received at 810, 820, 830, and/or 840 may be received at parking manager 100 via a resource such as networks 560. Parking manager 100 may receive data from resources such as server 550 (e.g., parking regulation information, event information, construction or traffic information, weather information, and/or other relevant information that may affect parking).

The process may include analyzing (at 860) the received sensor data. Data may be analyzed in various appropriate ways. For instance, some embodiments may apply machine learning models or other artificial intelligence (AI) resources to analyze the received data. Analysis may include, for instance, evaluation of image data, matching of data from different sources (e.g., a user description of a location entered via a GUI may be matched to GPS data received from a user device 520).

As shown, process 800 may include identifying (at 870) associated parking spaces. Associated parking spaces may include, for instance, a space that has been occupied during the parking event, a space that has been vacated during the parking event, image data or other relevant data related to a nearby space, etc. Parking spaces may be identified via a resource such as a lookup table of parking space structures 610 that is searchable by location and/or other criteria.

Process 800 may include identifying and applying (at 880) relevant updates. Thus, for example, information such as a status of a parking space structure 610 may be updated based on the identified event (e.g., a previously vacant space may be updated to “occupied” after a vehicle parks in the space, a previously occupied space may be updated to “vacant” after a vehicle leaves the space, a space status may be updated to “vacant” from “unknown” based on analysis of image data, etc.).

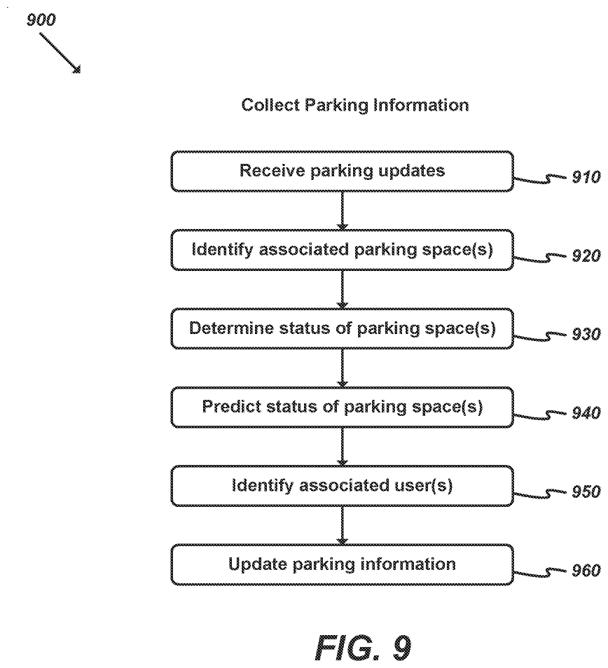

FIG. 9 illustrates an example process 900 for collecting parking information. Such parking information may be collected across a range of users, vehicles, spaces, regions, etc. The process may be performed whenever parking updates are received and/or under other appropriate circumstances (e.g., at regular intervals, when a specified number of updates is received, etc.). In some embodiments, process 900 may be performed by parking manager 100.

As shown, process 900 may include receiving (at 910) parking updates. Parking updates may be received at the parking manager 100 from various other resources such as user devices 520, vehicles 530, servers 550, etc.

Process 900 may include identifying (at 920) associated parking spaces. As described above, in some cases the update may indicate the parking space, such as by providing a parking space identifier. In some cases, received data may be analyzed to identify the associated parking space(s), such as GPS data, image data, etc.

The process may include determining (at 930) a status of the associated parking spaces. The status may be selected from a set of discrete values (e.g., “vacant”, “occupied”, “unknown”, “special”, “unavailable”, and/or other appropriate values). The status may be determined by analyzing received data (e.g., an arrival parking event may cause a status to be updated from “vacant” to “occupied”, while a departure parking event may cause a status to be updated from “occupied” to “vacant”). Some embodiments may utilize AI models to determine a status of each space. For example, image data may be analyzed to determine the status of each space.

As shown, process 900 may include predicting (at 940) a status of the associated parking spaces. Such predictions may be based on received data, historical data associated with a user or vehicle, and/or other relevant information (e.g., parking regulations, time until meter expires, etc.). The predictions may utilize AI models to predict a future status of the parking spaces.

Process 900 may include identifying (at 950) associated users. Associated users may be identified via vehicle information (e.g., by using a vehicle identifier associated with received sensor data to retrieve a vehicle structure 630 and extracting an associated entity identifier), user device information (e.g., by using a user device identifier associated with a received message including data received via a GUI to retrieve a user device structure 640 and extracting an associated entity identifier), and/or other appropriate ways. Associated users may include users such as space holders, space seekers, space owners, and/or other entities associated with the updated parking spaces.

The process may include updating (at 960) parking information. Updating the parking information may include, for example, updating various data structures and/or other database elements stored at a resource such as storage 510.

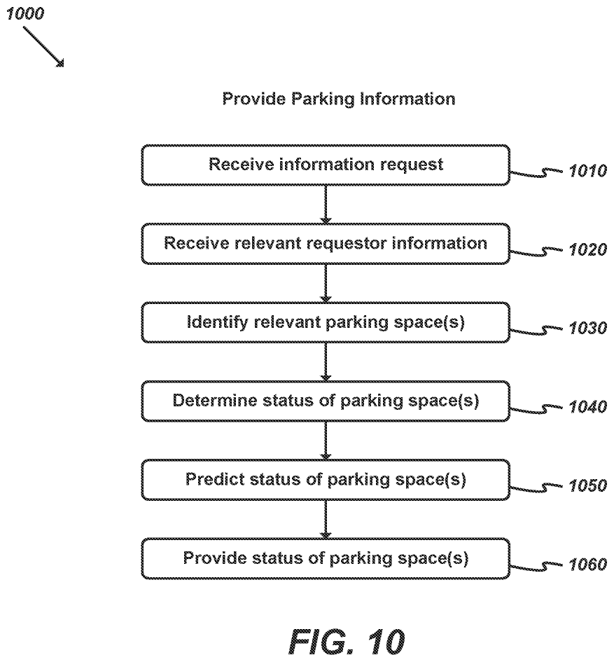

FIG. 10 illustrates an example process 1000 for providing parking information. The process may provide parking information to space seekers, space holders, and/or other relevant parties. The process may be performed whenever a request for information is received (e.g., when a user device application or web portal is accessed). In some embodiments, process 1000 may be performed by parking manager 100.

As shown, process 1000 may include receiving (at 1010) an information request. An information request may be received via a set of messages from an entity such as a user device 520, vehicle 530 (e.g., via a vehicle head unit), server 550, etc. The information request may generally indicate an area, such as that defined by a destination 410 and/or ROI 420. The information request may indicate other relevant information such as vehicle information (e.g., identifier, size, type, etc.), time of interest (e.g., current conditions, conditions at a specified time, etc.), and/or other relevant information.

Process 1000 may include receiving (at 1020) relevant requestor information. Such information may include, for instance, a listing of associated vehicles 530 and/or associated user devices 520, requestor identifier (e.g., username), and/or other relevant information (e.g., requestor preferences, historical data associated with the requestor, etc.). Requestor information may be received via resources such as data structures 610-640. For example, if a request is received via a vehicle head unit, the request may include a vehicle identifier for the associated vehicle 530 that may be used to look up a vehicle structure 630, which may indicate an associated entity identifier. Similarly, a requestor may be identified via a user device structure 640 for requests received via the associated user device 520.

The process may include identifying (at 1030) relevant parking spaces. Relevant parking spaces may be identified in various appropriate ways, depending on the received request. For instance, if a user indicates a desire to locate parking near a destination 410, parking spaces within the ROI 520 may be identified using location information associated with each space (e.g., via location information stored using parking space structure 610). Spaces within the ROI 520 may be filtered based on various relevant criteria (e.g., disabled spaces may be removed or omitted if the associated user does not have the appropriate status, spaces that are unavailable due to construction or weather may be removed or omitted, etc.).

As shown, process 1000 may include determining (at 1040) a status of the relevant parking spaces. The statuses may be determined using a resource such as parking space structure 610, where each relevant space may be associated with a space identifier that may be used to look up the space attributes, such as current or predicted status (as may be provided via a process such as process 900).

Process 1000 may include predicting (at 1050) a status of the relevant parking spaces. Such a prediction may be similar to predicting (at 940) the status as described above. The prediction may be based at least partly on information included or associated with the request, such as planned arrival time.

The process may include providing (at 1060) the status of the relevant parking spaces. Such statuses may be provided via a resource such as GUI 400.

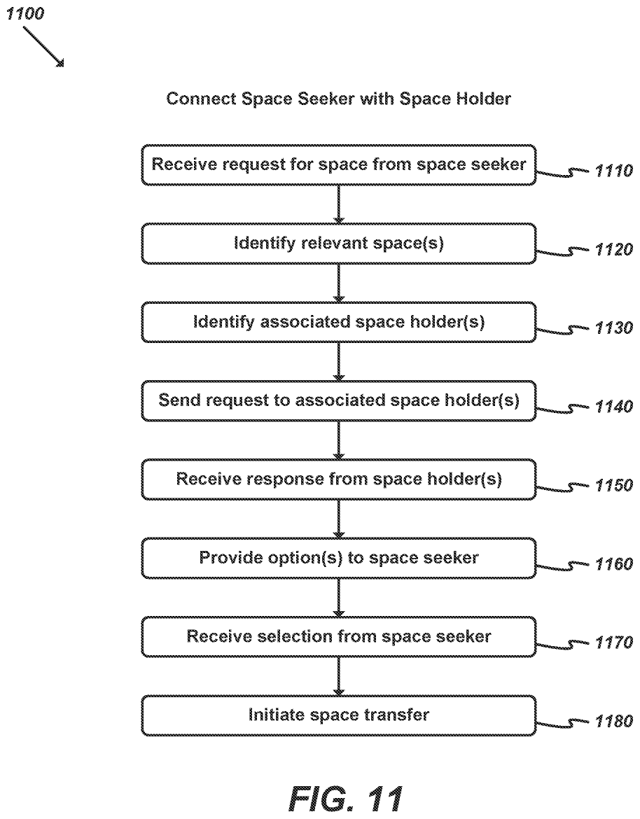

FIG. 11 illustrates an example process 1100 for connecting a space seeker with a space holder. Such a process may allow a space seeker to compensate a space holder and/or otherwise to facilitate a smooth transfer. The process may be performed whenever a space seeker launches a user device application or accesses a web portal of some embodiments. In some embodiments, process 1100 may be performed by parking manager 100.

As shown, process 1100 may include receiving (at 1110) a request for a space from a space seeker. A space request may be received via a set of messages from an entity such as a user device 520, vehicle 530 (e.g., via a vehicle head unit), etc. The space request may generally indicate an area, such as that defined by a destination 410 and/or ROI 420. The space request may indicate other relevant information such as vehicle information (e.g., identifier, size, type, etc.), time of arrival, and/or other relevant information. The space request may include or reference information such as a requestor identifier. The space request may indicate proposed compensation information (e.g., a maximum fee, an offer price, etc.).

Process 1100 may include identifying (at 1120) relevant spaces. Relevant parking spaces may be identified in various appropriate ways, depending on the received request. For instance, if a user indicates a desire to locate parking near a destination 410, parking spaces within the ROI 520 may be identified using location information associated with each space (e.g., via location information stored using parking space structure 610). Spaces within the ROI 520 may be filtered based on various relevant criteria (e.g., a user may indicate a preference for on-street rather than garage parking, a user may indicate individual spaces, etc.).

The process may include identifying (at 1130) space holders associated with the relevant spaces, if any. Space holders may be identified in various appropriate ways. For example, each parking space element 610 may include or reference a sub-element that indicates the identity of a space holder, if known. As another example, updates received from space holders may be analyzed to identify an associated user device 520 or vehicle 530 that may be used to identify an associated user or other entity via a lookup table of user device structures 640 or vehicle structures 630.

As shown, process 1100 may include sending (at 1140) requests to the associated space holders. Such requests may be sent via a resource such as a user device 520 or a head unit of a vehicle 530. In some embodiments, such requests may be published via an API or similar resource such that known and/or unknown space holders may utilize resources such as a user device application or web portal to evaluate whether a request is applicable and/or whether the offered terms (if any) are acceptable.

Process 1100 may include receiving (at 1150) a response from at least one space holder. The response may include information such as, for example, an entity identifier associated with the user, a space identifier or location, a minimum expected compensation, and/or other relevant information (e.g., planned time of departure, latest time of departure, etc.).

The process may include providing (at 1160) options to the space seeker. Responses may be sent to the space seeker via a resource such as a user device application, messaging service, and/or other appropriate ways (e.g., by updating a database associated with a web portal). Such options may include information such as space location (where the exact location may not be revealed until the space transfer), expected compensation, time of departure, etc.

As shown, process 1100 may include receiving (at 1170) a selection from the space seeker. The selection may be received via a GUI or other appropriate resource provided via a user device application, web portal, or other similar channel.

Process 1100 may include initiating (at 1180) a space transfer. Such initiation may include sending sets of messages to the space seeker and/or space holder indicating the parameters associated with the transfer (e.g., compensation, planned transfer time, etc.).

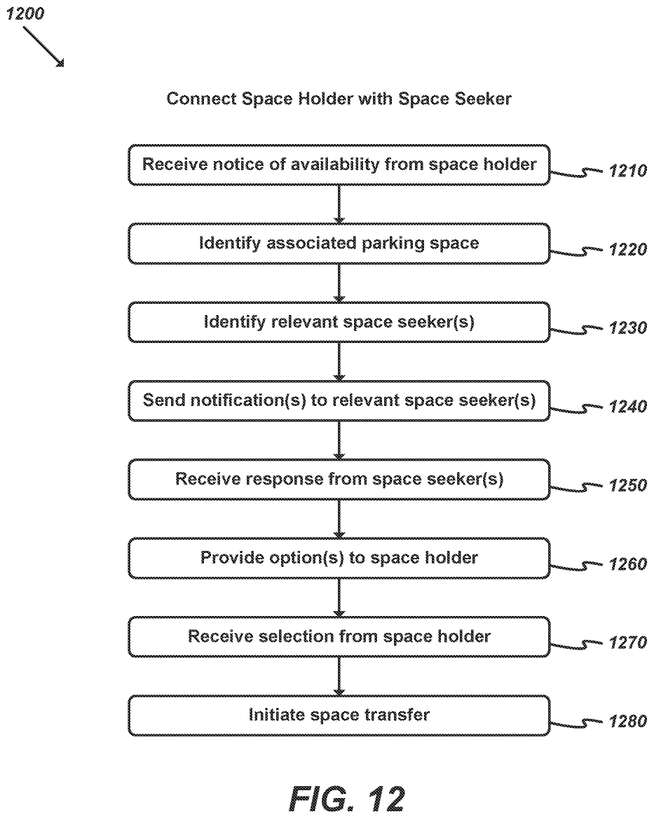

FIG. 12 illustrates an example process 1200 for connecting a space holder with a space seeker. Such a process may allow a space holder to seek compensation and/or otherwise facilitate transfer to a space seeker. The process may be performed whenever a space holder launches a user device application or accesses a web portal of some embodiments. In some embodiments, process 1200 may be performed by parking manager 100.

As shown, process 1200 may include receiving (at 1210) a notice of availability from a space holder. The notice of availability may be received via a set of messages from a resource such as a user device 520 or head unit of a vehicle 530. The notice of availability may include information such as space location or identifier, expected time of availability, type of listing (e.g., flat fee for transfer, auction, etc.), expected compensation (e.g., minimum auction price, flat fee request, etc.), etc.

The process may include identifying (at 1230) an associated parking space. The parking space may be identified in various appropriate ways. For instance, a space identifier may be extracted from the notice of availability. As another example, a location associated with the notice of availability (e.g., a GPS position provided by a user device 520 or vehicle 530) may be compared to locations associated with parking spaces to identify a specific parking space.

Process 1200 may include identifying (at 1230) relevant space seekers. Space seekers may be identified in various relevant ways. For example, the notice of availability may be compared to received requests for spaces to determine if any open requests may be satisfied by the offer.

The process may include sending (at 1240) notifications to the relevant space seekers. Such notifications may include, for example, push messages sent to space seekers associated with open requests for spaces that match the offered space. As another example, a database may be updated by parking manager 100 and any users that are evaluating a ROI via a resource such as GUI 400 may be able to see the offered space and any associated terms.

As shown, process 1200 may include receiving (at 1250) a response from at least one space seeker. Such a response may include information such as, for example, maximum compensation (or agreement to requested compensation, or a bid for an auction space, etc.), expected time of arrival, and/or other relevant information.

Process 1200 may include providing (at 1260) options to the space holder. Responses may be sent to the space holder via a resource such as a user device application, messaging service, and/or other appropriate ways (e.g., by updating a database associated with a web portal). Such options may include information such as proposed compensation, time of arrival, etc.

As shown, process 1200 may include receiving (at 1270) a selection from the space holder. The selection may be received via a GUI or other appropriate resource provided via a user device application, web portal, or other similar channel.

Process 1200 may include initiating (at 1280) a space transfer. Such initiation may include sending sets of messages to the space seeker and/or space holder indicating the parameters associated with the transfer (e.g., compensation, planned transfer time, etc.).

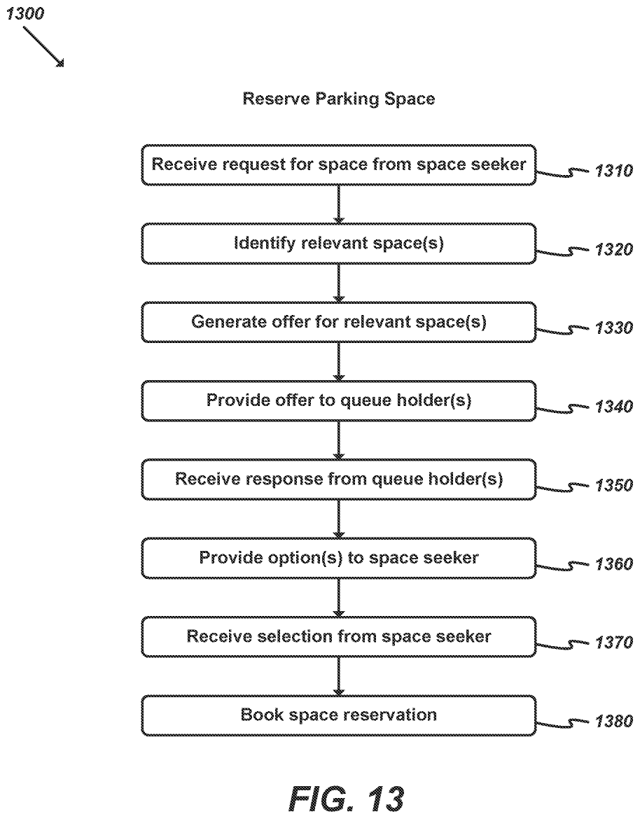

FIG. 13 illustrates an example process 1300 for reserving a parking space. Such a process may allow a user to reserve a specific space for a specific time. For instance, if a user has a downtown appointment at 10am on a Tuesday morning, the user may wish to reserve a space in front of the establishment associated with the appointment (e.g., street parking in front of a specified hotel or restaurant). The process may be performed whenever a space seeker launches a user device application or accesses a web portal of some embodiments. In some embodiments, process 1300 may be performed by parking manager 100.

As shown, process 1300 may include receiving (at 1310) a request for a space from a space seeker. The request may be similar to that described above and may indicate a ROI (or even a specific space), time of arrival, proposed compensation, and/or other relevant information.

Process 1300 may include identifying (at 1320) relevant spaces. Relevant spaces may be identified based on the ROI and/or other relevant information (e.g., a listing of specific spaces provided by the space seeker).

The process may include generating (at 1330) an offer for relevant spaces. The offer may include a listing of relevant spaces, offered compensation, time of arrival, and/or other relevant information.

As shown, process 1300 may include providing (at 1340) the offer to queue holders. The offer may be provided via resources such as user device applications, web portals, push messaging, etc. Some users may identify as queue holders and may receive alerts or push messages for such offers related to the area of operation for the user.

Process 1300 may include receiving (at 1350) a response from at least one queue holder. The response may include information such as, for example, an entity identifier associated with the user, a space identifier or location, and/or other relevant information (e.g., latest time of departure).

The process may include providing (at 1360) options to the space seeker. Responses may be sent to the space seeker via a resource such as a user device application, messaging service, and/or other appropriate ways (e.g., by updating a database associated with a web portal). Such options may include information such as space location (where the exact location may not be revealed until the space transfer), queue holder identity, etc.

As shown, process 1300 may include receiving (at 1370) a selection from the space seeker. The selection may be received via a GUI or other appropriate resource provided via a user device application, web portal, or other similar channel.

Process 1300 may include booking (at 1380) the space reservation. Such booking may include sending sets of messages to the space seeker and/or space holder indicating the parameters associated with the transfer (e.g., space location or list of acceptable spaces, compensation, planned transfer time, etc.). A space transfer may be initiated at the transfer time specified by the space reservation.

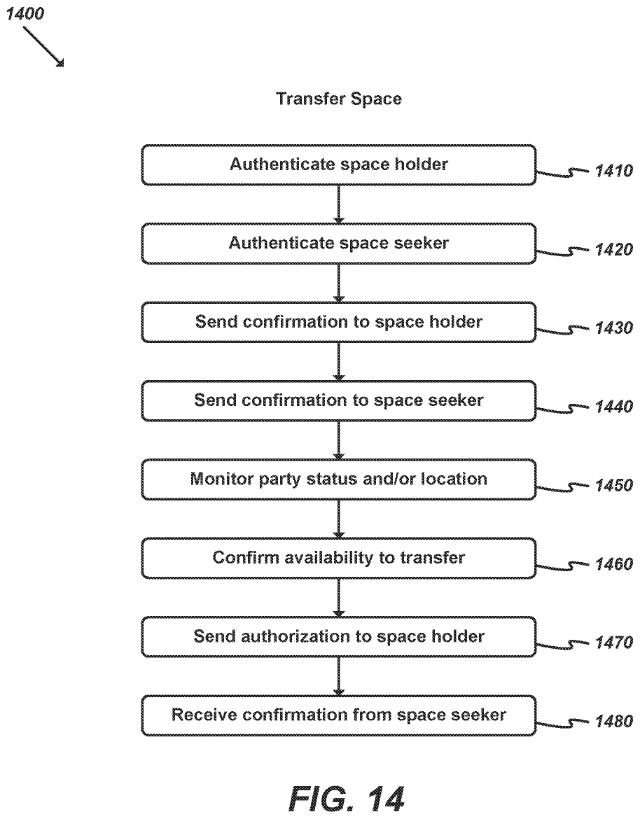

FIG. 14 illustrates an example process 1400 for transferring a parking space. The process may be performed to complete space transfers initiated via process 1100, 1200, or 1300. The process may be performed whenever a space transfer is initiated. In some embodiments, process 1400 may be performed by parking manager 100.

As shown, process 1400 may include authenticating (at 1410) the space holder. The space holder may be authenticated using a process such as process 1500.

Process 1400 may include authenticating (at 1420) the space seeker. The space seeker may be authenticated using a process such as process 1500.

The process may include sending (at 1430) a confirmation to the space holder. Such confirmation may include, for instance, confirmation of compensation amount or terms, confirmation of transfer time, identifying information related to the space seeker (e.g., vehicle make and model), and/or other relevant information. The confirmation may be sent via a resource such as push messaging, a user device application or web portal of some embodiments, and/or via other appropriate channels.

As shown, process 1400 may include sending (at 1440) a confirmation to the space seeker. Such confirmation may include, for instance, confirmation of compensation amount or terms, confirmation of transfer time, identifying information related to the space holder (e.g., vehicle make and model), detailed space location information, and/or other relevant information. The confirmation may be sent via a resource such as push messaging, a user device application or web portal of some embodiments, and/or via other appropriate channels.

Process 1400 may include monitoring (at 1450) party status and/or location. For instance, GPS data associated with space seeker may be monitored to predict arrival time. As another example, the space seeker may provide an update or cancelation notice (e.g., if the space is no longer needed, some compensation may still be provided, but the transfer may be canceled).

The process may include confirming (at 1460) availability to transfer. Such confirmation may include, for instance, monitoring location of a user device 520 associated with the space holder to ensure that the space holder is present at the space to be transferred. As another example, the space holder may reply to a set of messages or use a resource such as a web portal or user device application of some embodiments to indicate or verify availability.

As shown, process 1400 may include sending (at 1470) authorization to the space holder. Such authorization may include, for instance, confirmation that payment has been received, confirmation that the space seeker is present at or near the space to be transferred, and/or other relevant information.

Process 1400 may include receiving (at 1480) confirmation from the space seeker. Such confirmation may include, for example, monitoring GPS data for a vehicle 530 or user device 520 associated with the space seeker to determine that the space seeker is at or near the space to be transferred. As another example, the space seeker may use a resource such as a web portal or user device application of some embodiments to indicate or verify presence at or near the space to be transferred.

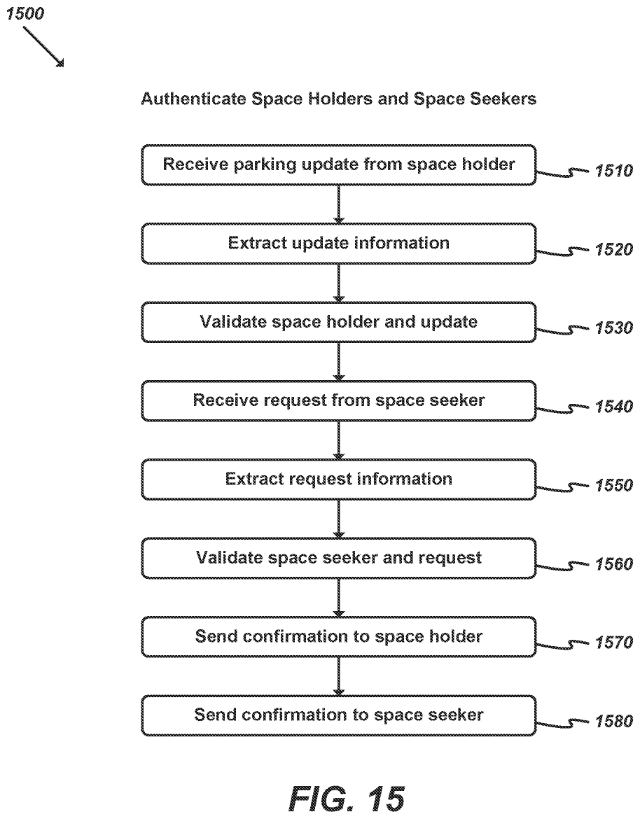

FIG. 15 illustrates an example process 1500 for authenticating space holders and space seekers. Such a process may allow space holders and space seekers to verify the identity of the other party, verify compensation, and/or to review or verify the status of a space holder or space seekers (e.g., by reviewing ratings of the user by other users of parking manager 100). The process may be performed whenever a user logs on to an application or web portal, when a request for a space is initiated, when a reservation is requested, when users agree to transfer terms, and/or under other appropriate conditions. In some embodiments, process 1500 may be performed by parking manager 100.

As shown, process 1500 may include receiving (at 1510) a parking update from a space holder. Such an update may include, for example, information such as a space identifier, user device information, vehicle information, and/or other information related to components associated with the space holder.

Process 1500 may include extracting (at 1520) update information. Such extracted information may include, for example, position information (e.g., GPS data), user account information such as username and password, and/or other relevant information that may be used to verify user identity (e.g., payment information such as a credit card or bank account information).

The process may include validating (at 1530) the space holder and the update. Such validation may include, for example, comparison of received GPS data to a location of the parking space, verification of payment credentials via a third-party resource, comparison of username and password to a database of authorized users, etc.

As shown, process 1500 may include receiving (at 1540) a request from a space seeker. Such a request may include information such as, for instance, an ROI, a space identifier, user device information, vehicle information, and/or other information related to components associated with the space seeker.

Process 1500 may include extracting (at 1550) request information. Such extracted information may include, for example, position information (e.g., GPS data), user account information such as username and password, and/or other relevant information that may be used to verify user identity (e.g., payment information such as a credit card or bank account information).

The process may include validating (at 1560) the space seeker and the request. Such validation may include, for example, comparison of received GPS data to the ROI to determine user proximity to the requested space or area, verification of payment credentials via a third-party resource, comparison of username and password to a database of authorized users, etc.

As shown, process 1500 may include sending (at 1570) a confirmation to the space holder. If the space seeker information is successfully verified, the confirmation may be sent. If the information is not successfully verified, a denial may be sent to the space holder.

Process 1500 may include sending (at 1580) a confirmation to the space seeker. If the space holder information is successfully verified, the confirmation may be sent. If the information is not successfully verified, a denial may be sent to the space seeker.

One of ordinary skill in the art will recognize that processes 700-1500 may be implemented in various different ways without departing from the scope of the disclosure. For instance, the elements may be implemented in a different order than shown. As another example, some embodiments may include additional elements or omit various listed elements. Elements or sets of elements may be performed iteratively and/or based on satisfaction of some performance criteria. Non-dependent elements may be performed in parallel. Elements or sets of elements may be performed continuously and/or at regular intervals.

The processes and modules described above may be at least partially implemented as software processes that may be specified as one or more sets of instructions recorded on a non-transitory storage medium. These instructions may be executed by one or more computational element(s) (e.g., microprocessors, microcontrollers, digital signal processors (DSPs), application-specific integrated circuits (ASICs), field programmable gate arrays (FPGAs), other processors, etc.) that may be included in various appropriate devices in order to perform actions specified by the instructions.

As used herein, the terms “computer-readable medium” and “non-transitory storage medium” are entirely restricted to tangible, physical objects that store information in a form that is readable by electronic devices.

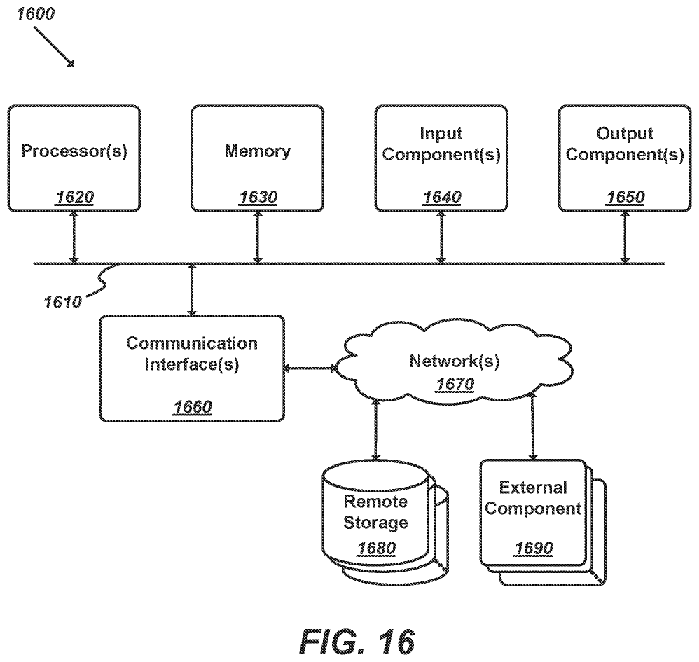

FIG. 16 illustrates a schematic block diagram of an exemplary device (or system or devices) 1600 used to implement some embodiments. For example, the systems, devices, components, and/or operations described above in reference to FIG. 1, FIG. 2, FIG. 3, FIG. 4, FIG. 5, and FIG. 6 may be at least partially implemented using device 1600. As another example, the processes described in reference to FIG. 7, FIG. 8, FIG. 9, FIG. 10, FIG. 11, FIG. 12, FIG. 13, and FIG. 15 may be at least partially implemented using device 1600.

Device 1600 may be implemented using various appropriate elements and/or sub-devices. For instance, device 1600 may be implemented using one or more personal computers (PCs), servers, mobile devices (e.g., smartphones), tablet devices, wearable devices, and/or any other appropriate devices. The various devices may work alone (e.g., device 1600 may be implemented as a single smartphone) or in conjunction (e.g., some components of the device 1600 may be provided by a mobile device while other components are provided by a server).

As shown, device 1600 may include at least one communication bus 1610, one or more processors 1620, memory 1630, input components 1640, output components 1650, and one or more communication interfaces 1660.

Bus 1610 may include various communication pathways that allow communication among the components of device 1600. Processor 1620 may include a processor, microprocessor, microcontroller, DSP, logic circuitry, and/or other appropriate processing components that may be able to interpret and execute instructions and/or otherwise manipulate data. Memory 1630 may include dynamic and/or non-volatile memory structures and/or devices that may store data and/or instructions for use by other components of device 1600. Such a memory device 1630 may include space within a single physical memory device or spread across multiple physical memory devices.

Input components 1640 may include elements that allow a user to communicate information to the computer system and/or manipulate various operations of the system. The input components may include keyboards, cursor control devices, audio input devices and/or video input devices, touchscreens, motion sensors, etc. Output components 1650 may include displays, touchscreens, audio elements such as speakers, indicators such as light-emitting diodes (LEDs), printers, haptic or other sensory elements, etc. Some or all of the input and/or output components may be wirelessly or optically connected to the device 1600.

Device 1600 may include one or more communication interfaces 1660 that are able to connect to one or more networks 1670 or other communication pathways. For example, device 1600 may be coupled to a web server on the Internet such that a web browser executing on device 1600 may interact with the web server as a user interacts with an interface that operates in the web browser. Device 1600 may be able to access one or more remote storages 1680 and one or more external components 1690 through the communication interface 1660 and network 1670. The communication interface(s) 1660 may include one or more APIs that may allow the device 1600 to access remote systems and/or storages and also may allow remote systems and/or storages to access device 1600 (or elements thereof).

It should be recognized by one of ordinary skill in the art that any or all of the components of computer system 1600 may be used in conjunction with some embodiments. Moreover, one of ordinary skill in the art will appreciate that many other system configurations may also be used in conjunction with some embodiments or components of some embodiments.

In addition, while the examples shown may illustrate many individual modules as separate elements, one of ordinary skill in the art would recognize that these modules may be combined into a single functional block or element. One of ordinary skill in the art would also recognize that a single module may be divided into multiple modules.

Device 1600 may perform various operations in response to processor 1620 executing software instructions stored in a computer-readable medium, such as memory 1630. Such operations may include manipulations of the output components 1650 (e.g., display of information, haptic feedback, audio outputs, etc.), communication interface 1660 (e.g., establishing a communication channel with another device or component, sending and/or receiving sets of messages, etc.), and/or other components of device 1600.

The software instructions may be read into memory 1630 from another computer-readable medium or from another device. The software instructions stored in memory 1630 may cause processor 1620 to perform processes described herein. Alternatively, hardwired circuitry and/or dedicated components (e.g., logic circuitry, ASICs, FPGAs, etc.) may be used in place of or in combination with software instructions to implement processes described herein. Thus, implementations described herein are not limited to any specific combination of hardware circuitry and software.

The actual software code or specialized control hardware used to implement an embodiment is not limiting of the embodiment. Thus, the operation and behavior of the embodiment has been described without reference to the specific software code, it being understood that software and control hardware may be implemented based on the description herein.

While certain connections or devices are shown, in practice additional, fewer, or different connections or devices may be used. Furthermore, while various devices and networks are shown separately, in practice the functionality of multiple devices may be provided by a single device or the functionality of one device may be provided by multiple devices. In addition, multiple instantiations of the illustrated networks may be included in a single network, or a particular network may include multiple networks. While some devices are shown as communicating with a network, some such devices may be incorporated, in whole or in part, as a part of the network.

Some implementations are described herein in conjunction with thresholds. To the extent that the term “greater than” (or similar terms) is used herein to describe a relationship of a value to a threshold, it is to be understood that the term “greater than or equal to” (or similar terms) could be similarly contemplated, even if not explicitly stated. Similarly, to the extent that the term “less than” (or similar terms) is used herein to describe a relationship of a value to a threshold, it is to be understood that the term “less than or equal to” (or similar terms) could be similarly contemplated, even if not explicitly stated. Further, the term “satisfying,” when used in relation to a threshold, may refer to “being greater than a threshold,” “being greater than or equal to a threshold,” “being less than a threshold,” “being less than or equal to a threshold,” or other similar terms, depending on the appropriate context.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

The foregoing relates to illustrative details of exemplary embodiments and modifications may be made without departing from the scope of the disclosure. Even though particular combinations of features are recited in the claims and/or disclosed in the specification, these combinations are not intended to limit the possible implementations of the disclosure. In fact, many of these features may be combined in ways not specifically recited in the claims and/or disclosed in the specification. For instance, although each dependent claim listed below may directly depend on only one other claim, the disclosure of the possible implementations includes each dependent claim in combination with every other claim in the claim set.

We claim:

1. A device, comprising:
one or more processors configured to:
receive a parking update;
analyze the parking update to identify an associated parking space; and
determine a status of the associated parking space.

2. The device of claim 1, the one or more processors further configured to:
receive an information request related to the associated parking space; and
provide the status of the parking space.

3. The device of claim 1, the one or more processors further configured to predict a future status of the associated parking space.

4. The device of claim 1, wherein the status of the associated parking space is occupied and the one or more processors are further configured to receive a request to transfer the associated parking space from a space seeker.

5. The device of claim 4, wherein the request to transfer comprises a compensation amount.

6. The device of claim 5, the one or more processors further configured to send the request to transfer to a space holder.

7. The device of claim 6, the one or more processors further configured to:
authenticate the space holder;
authenticate the space seeker; and
initiate a space transfer of the associated parking space.

8. A non-transitory computer-readable medium, storing a plurality of processor-executable instructions to:
receive a parking update;
analyze the parking update to identify an associated parking space; and
determine a status of the associated parking space.

9. The non-transitory computer-readable medium of claim 8, the plurality of processor-executable instructions further to
receive an information request related to the associated parking space; and
provide the status of the parking space.

10. The non-transitory computer-readable medium of claim 8, the plurality of processor-executable instructions further to predict a future status of the associated parking space.

11. The non-transitory computer-readable medium of claim 8, wherein the status of the associated parking space is occupied and the plurality of processor-executable instructions are further configured to receive a request to transfer the associated parking space from a space seeker.

12. The non-transitory computer-readable medium of claim 11, wherein the request to transfer comprises a compensation amount.

13. The non-transitory computer-readable medium of claim 12, the plurality of processor-executable instructions further to send the request to transfer to a space holder.

14. The non-transitory computer-readable medium of claim 13 the plurality of processor-executable instructions further to:
authenticate the space holder;
authenticate the space seeker; and
initiate a space transfer of the associated parking space.

15. A method comprising:
receiving a parking update;
analyzing the parking update to identify an associated parking space; and
determining a status of the associated parking space.

16. The method of claim 15 further comprising:
receiving an information request related to the associated parking space; and
providing the status of the parking space.

17. The method of claim 15 further comprising predicting a future status of the associated parking space.

18. The method of claim 15, wherein the status of the associated parking space is occupied and the method further comprising receiving a request to transfer the associated parking space from a space seeker.

19. The method of claim 18, wherein the request to transfer comprises a compensation amount.

20. The method of claim 15 further comprising:
sending the request to transfer to a space holder;
authenticating the space holder;
authenticating the space seeker; and
initiating a space transfer of the associated parking space.
